(19) United States
(12) Patent Application Publication
(10) Pub. No.: US 2026/0133347 A1
(43) Pub. Date: May 14, 2026

(54) BLACK LIGHT SHIELDING COMPONENT

(71) Applicant: SOMAR CORPORATION, Tokyo (JP)

(72) Inventor: Hiroshi NAMAI, Tokyo (JP)

(21) Appl. No.: 18/868,748

(22) PCT Filed: May 23, 2023
(86) PCT No.: PCT/JP2023/019188

§ 371 Date: Oct. 22, 2025

(30) Foreign Application Priority Data
May 24, 2022 (JP) 2022-084882

(51) Int. Cl. G02B 1/113; C09D 5/03; C09D 7/40; C09D 7/61; G02B 5/00; G02B 5/20

(52) U.S. Cl. CPC G02B 1/113; C09D 5/035; C09D 7/61; C09D 7/67; C09D 7/69; G02B 5/003; G02B 5/206

(57) ABSTRACT

The present invention provides a black light shielding component with low gloss and high blackness, capable of achieving a black color close to pure black. The black light shielding component comprises a substrate and a light shielding layer (3) formed on at least one surface of the substrate. The light shielding layer (3) contains black microparticles, chain-like structure materials (33), and a resin component (31). By using chain-like silica as the chain-like structure materials (33), an L value of 7 or less, a spectral reflectance of 0.8% or less for light at a wavelength of 360 nm, and a highly black, near-pure black color can be achieved.

### FIELD OF THE INVENTION

The present invention relates to a black light shielding component. More specifically, the invention relates to a black light shielding component suitable for optical instruments such as camera units used in mobile phones, including smartphones.

### BACKGROUND OF THE INVENTION

Light shielding components are typically used in the lens apertures, shutters, and lens spacers of cameras.

As such light shielding components, it is known to use a black film formed on the surface of a black polyester substrate containing black pigments such as carbon black, where the film has a prescribed uneven shape. In this configuration, by controlling the fine unevenness of the surface of the light shielding layer, light can be effectively scattered, and the black pigment absorbs the light to reduce reflected light, thereby achieving low gloss. Methods for forming the aforementioned uneven shape include covering the surface of the substrate with a light shielding layer containing a matting agent, and roughening the surface of the substrate by means such as sandblasting.

Patent Document 1 describes the following: using the methods described above, the arithmetic mean roughness Ra, in accordance with JIS B0601:2001, of the surface of the light shielding component is adjusted to 0.5 μm or more, and the difference between the maximum peak height (Rp) and the maximum valley depth (Rv) (Rp−Rv) is less than 3. As a result, a light shielding component having such a surface shape exhibits excellent anti-reflection properties even when thinned, has high hardness, and provides excellent adhesion between the light shielding layer and the film substrate, thus maintaining superior low gloss for an extended period.

### PRIOR ART DOCUMENTS

### Patent Documents

Patent Document 1: International Publication WO2018/052044

### SUMMARY OF THE INVENTION

### Technical Problem to be Solved

In recent years, light shielding components for optical instruments have been pursued to achieve a higher level of blackness, particularly to enhance the design aesthetics. However, with conventional light shielding components, light scattering on the surface of the light shielding layer causes whitening, making it difficult to achieve both low gloss and high blackness simultaneously. Although increasing the amount of black microparticles can enhance the blackness while maintaining low gloss, this leads to issues such as peeling of the light shielding layer and reduced processability.

The inventors of the present invention discovered, through research, that in a black light shielding component with a substrate and a light shielding layer formed on at least one surface of the substrate, by adding fine black microparticles and low refractive index nanoparticles to the resin component of the light shielding layer, a light shielding component with low gloss, high blackness, and excellent processability can be obtained (PCT/JP2021/042871, hereinafter referred to as the “prior art”). It was confirmed that this black light shielding component has an L* value of 10 or less, providing high blackness and excellent design aesthetics. However, it was found that the black color obtained from the prior art sometimes appears bluish and does not sufficiently meet the requirements for uses demanding a near-pure black color.

### Technical Solution to the Problem

In view of the above technical problems, the inventors conducted extensive research and discovered that by adding a chain-like structure material to the light shielding layer of the black light shielding component, the reflectivity on the lower wavelength side can be reduced, achieving a black color closer to pure black. This led to the present invention. Specifically, the black light shielding component of the present invention includes a substrate and a light shielding layer formed on at least one surface of the substrate, characterized in that the light shielding layer contains black microparticles, a chain-like structure material, and a resin component.

Preferably, the chain-like structure material contains a chain-like structure material with a low refractive index (hereinafter referred to as a “low refractive index chain-like structure material”).

Preferably, the low refractive index chain-like structure material contains chain-like silica.

Additionally, the light shielding layer may also contain low refractive index nanoparticles (excluding the low refractive index chain-like structure materials).

Preferably, the low refractive index nanoparticles contain magnesium fluoride particles.

Preferably, the total content of the black microparticles and the chain-like structure materials in the light shielding layer is 50% to 95% by volume of the entire light shielding layer.

Preferably, the total content of the black microparticles, the chain-like structure materials, and the low refractive index nanoparticles in the light shielding layer is 40% to 95% by volume of the entire light shielding layer.

Preferably, the content of the chain-like structure materials is 1% to 50% by volume of the total volume of the black microparticles and the chain-like structure materials.

Furthermore, another black light shielding component of the present invention includes a substrate and a light shielding layer formed on at least one surface of the substrate, characterized in that the light shielding layer contains black microparticles, a chain-like structure material, and a resin component, and the surface of the black light shielding component with the light shielding layer has a spectral reflectivity at a wavelength of 360 nm of 0.8% or less.

Preferably, the chain-like structure material contains chain-like silica.

The black light shielding component may also contain magnesium fluoride particles.

Additionally, the present invention provides a black coating composition, characterized in that it contains black microparticles, a chain-like structure material, and a resin component.

Preferably, the chain-like structure material contains chain-like silica.

The black coating composition may also contain magnesium fluoride particles.

In the present invention, low refractive index nanoparticles refer to particles excluding the low refractive index chain-like structure material.

### Effects of the Invention

The black light shielding component of the present invention exhibits low gloss, high blackness, and a black color that is close to pure black. Therefore, it offers excellent design aesthetics and is suitable for use in camera units of mobile phones such as smartphones. Furthermore, next-generation displays that use black sheets to display black often suffer from a bluish tint. However, the black light shielding component of the present invention provides a black color that is closer to pure black, making it particularly well-suited for such applications. Additionally, the light shielding layer of the black light shielding component of the present invention adheres well to the substrate, suppressing the peeling of the coating film of the light shielding layer during punching or cutting processes, thereby offering excellent processability.

### BRIEF DESCRIPTION OF THE DRAWINGS

FIG. 1 is a schematic cross-sectional view illustrating the structure of the black light shielding component of the present invention.

FIG. 2(A) is a schematic cross-sectional view illustrating the attenuation behavior of incident light in the black light shielding component of the present invention, while FIG. 2(B) and FIG. 2(C) are schematic cross-sectional views illustrating the attenuation behavior of incident light in the black light shielding component of the prior art.

FIG. 3 is a graph showing the spectral reflectivity in the visible light range of the black light shielding components in Example 1, Comparative Example 1, and Comparative Example 2.

FIG. 4 is a graph showing the spectral reflectivity in the visible light range of the black light shielding components in Example 2, Comparative Example 3, and Comparative Example 4.

### DETAILED DESCRIPTION OF THE INVENTION

The embodiments of the present invention are described in detail below.

Additionally, in this specification, the range indicated by “˜” for numerical values represents a range that includes the values indicated as both the upper limit and lower limit. Furthermore, when only the unit for the upper limit is indicated in a numerical range, it is to be understood that the lower limit has the same unit as the upper limit.

In the staged numerical ranges described in this specification, the upper or lower limits of one numerical range can also be replaced with the upper or lower limits of other staged numerical ranges. Additionally, the upper or lower limits of a numerical range described in this specification can also be replaced with the values indicated in the examples.

Unless otherwise indicated, the content rate (content) or content amount of each component in the composition refers to the total content rate or content amount of various substances that exist as components of the composition when multiple substances correspond to the same component.

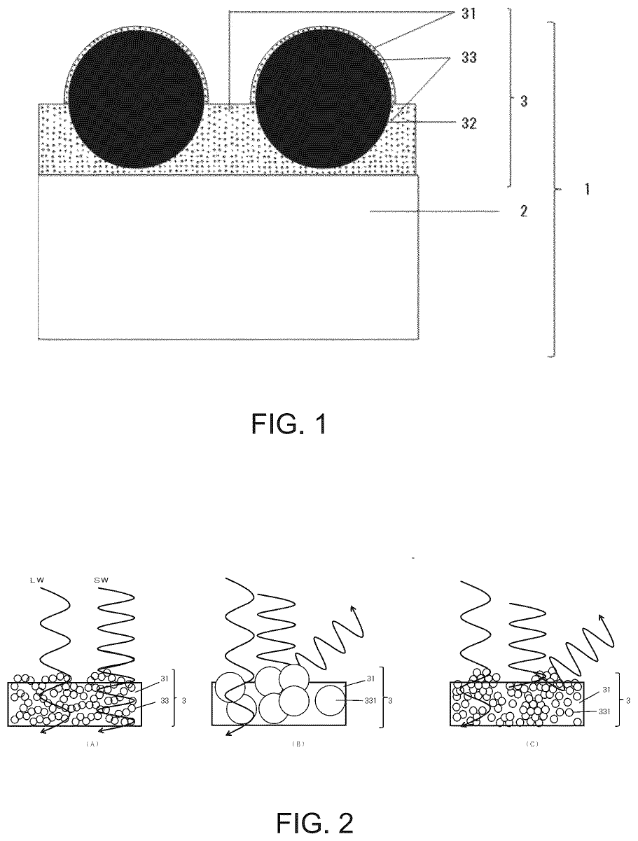

FIG. 1 is a schematic cross-sectional view illustrating the structure of the black light shielding component 1 of the present invention. The black light shielding component 1 of the present invention includes a substrate 2 and a light shielding layer 3 formed on at least one surface of the substrate 2. The light shielding layer 3 contains black microparticles 32, a chain-like structure material 33, and a resin component 31. Additionally, in FIG. 1, the chain-like structure material 33 is simplified and indicated as black dots only.

FIG. 2(B) and FIG. 2(C) are schematic cross-sectional views illustrating the attenuation behavior of incident light in the black light shielding component of the prior art. In the prior art, (spherical) low refractive index nanoparticles 331 are dispersed within the resin component 31. This reduces the refractive index of the light shielding layer 3, minimizing the difference in refractive index between the light shielding layer 3 and the air layer (n_{d}=1.00). As a result, it is thought that diffuse reflection on the surface of the light shielding layer 3 is reduced. Furthermore, the diffuse reflected light is absorbed and reflected by black microparticles (not shown in FIG. 2(B) and FIG. 2(C)), significantly attenuating the light. As a result, it is thought that the black light shielding component of the prior art can achieve low gloss and high blackness. In FIG. 2(B) and FIG. 2(C), the particle sizes of the added low refractive index nanoparticles 331 differ, but other structures remain the same.

Thus, while the black light shielding component of the prior art achieves high blackness, the obtained black sometimes has a bluish tint, making it difficult to apply to uses requiring a black color close to pure black. This can be attributed to the following reasons. As shown in FIGS. 2(B) and 2(C), the particle diameters of the low refractive index nanoparticles in the prior art are smaller than the wavelength of visible light, and therefore, most visible light is not reflected. However, when the particle size of the low refractive index nanoparticles is large (FIG. 2(B)) or the smaller nanoparticles are densely packed (aggregated) (FIG. 2(C)), visible light at shorter wavelengths reflects off the surface of the low refractive index nanoparticles, leading to an increase in reflectance on the shorter wavelength side, resulting in a bluish black color.

In contrast, in the black light shielding component of the present invention, where chain-like structure materials 33 are dispersed, as shown in FIG. 2(A), aggregation (dense packing) is less likely to occur within the light shielding layer 3. The primary particle size of the chain-like structure material 33 is smaller than the wavelength of visible light, and when not aggregated, the reflection of all visible light, including both long-wavelength light (LW in FIG. 2) and short-wavelength light (SW in FIG. 2), is suppressed. As a result, it is thought that a black color closer to pure black can be achieved.

Furthermore, it is believed that by adding the chain-like structure material 33, an uppermost surface layer containing air (n_{d}=1.00) is formed on the surface of the light shielding layer 3, and air is also drawn between the particles making up the chain-like structure within the light shielding layer 3, lowering the refractive index of the light shielding layer 3. This reduces the difference in refractive index between the light shielding layer 3 and the air layer, further suppressing the reflection of visible light on the surface of the light shielding layer 3, achieving a higher blackness (low L* value) and a black color closer to pure black.

As described later, in the present invention, low refractive index nanoparticles can also be dispersed within the resin component 31. This is believed to further reduce the refractive index of the light shielding layer 3, decrease the refractive index difference between the light shielding layer 3 and the air layer (n_{d}=1.00), reduce diffuse reflected light on the surface of the light shielding layer 3, and enable the achievement of low gloss and higher blackness.

Below, the specific material structure of the black light shielding component of the present invention will be described.

### (1) Substrate

The substrate used in the present invention is not particularly limited and may be either transparent or opaque. Materials for the substrate in the present invention can include resins, metals, and glass.

Examples of materials for resin substrates include polyolefins such as polyethylene, polypropylene, ethylene-propylene copolymers, and ethylene copolymers with α-olefins having 4 or more carbon atoms; polyesters such as polyethylene terephthalate; polyamides such as nylon; ethylene-vinyl acetate copolymers; polyvinyl chloride; polyvinyl acetate; other general-purpose plastics; or engineering plastics such as polycarbonate and polyimide.

In addition, as examples of metal substrates, substrates made of metals such as gold, silver, copper, aluminum, titanium, zinc, beryllium, nickel, or tin, and alloy substrates made of alloys such as phosphor bronze, copper-nickel, copper-beryllium, stainless steel, brass, or duralumin, can be used. For glass substrates, there are no particular limitations, and for example, ultra-thin sheet glass (such as G-Leaf® by Nippon Electric Glass Co., Ltd.) can be used.

Among these materials, biaxially stretched polyethylene terephthalate substrates are preferred due to their high strength, economy, and versatility. Furthermore, from the viewpoint of heat resistance, polyimide substrates are preferred, and in cases where higher heat resistance is required, metal substrates made of copper are preferred. For resin substrates, it is preferable to mix black pigments such as carbon black or aniline black in advance and adjust the optical density to 2 or more, preferably 4 or more, to obtain superior light shielding properties.

The thickness of the substrate is not particularly limited. When using a resin substrate, a thickness of 2 μm to 250 μm is preferred, with a more preferred range of 4 μm to 100 μm. By setting the thickness within this range, the substrate becomes suitable for small and thin optical components. For optical instruments such as camera units for mobile phones, a thickness of 4 μm to 20 μm is preferred.

When using a metal substrate, a thickness of 6 μm to 40 μm is preferred, and for optical instruments such as camera units for mobile phones, a thickness of 10 μm to 20 μm is preferred.

When using a glass substrate, a thickness of 5 μm to 200 μm is preferred, with a more preferred range of 10 μm to 100 μm. For optical instruments such as camera units for mobile phones, a thickness of 10 μm to 35 μm is preferred.

Flat substrates can be used, or substrates that have been subjected to matte processing to form irregularities (roughened portions) on the surface may also be used. By applying matte processing, it is possible to control the uneven shape of the surface of the light shielding component after the light shielding layer is applied, as well as to improve the adhesion between the substrate and the light shielding layer. The method of matte processing is not particularly limited, and known methods can be used. For example, in the case of resin substrates, methods such as chemical etching, blasting, embossing, calendering, corona discharge, plasma discharge, or chemical matte processing using resins and roughening agents can be employed. Additionally, the substrate may contain a matting agent to form irregularities directly on the surface of the resin substrate. Among these methods, blasting, especially sandblasting, is preferred from the viewpoints of ease of shape control, economy, and operability.

In the sandblasting method, the surface characteristics can be controlled by the particle size of the abrasive and the spraying pressure used. In the embossing method, the surface characteristics can be controlled by adjusting the shape and pressure of the embossing roller.

In the case of a metal substrate film, unevenness can be formed on the surface through methods such as blackening, blasting, or etching.

### (2) Anchor Layer

Before forming the light shielding layer on at least one surface of the substrate, an anchor layer can be provided to improve the adhesion between the substrate and the light shielding layer. As the anchor layer, urea resin layers, melamine resin layers, polyurethane resin layers, polyester resin layers, and the like can be used.

For example, a polyurethane resin layer can be obtained by applying a solution containing polyisocyanates, diamines, diols, or other compounds with active hydrogen to the surface of the substrate and curing it. In the case of urea resin layers or melamine resin layers, they can be obtained by applying a solution containing water-soluble urea resin or water-soluble melamine resin to the surface of the substrate and curing it. A polyester resin layer can be obtained by applying a solution dissolved or diluted in an organic solvent (such as methyl ethyl ketone or toluene) to the surface of the substrate and drying it.

### (3) Light Shielding Layer

The light shielding layer of the present invention is characterized by containing a resin component, black microparticles, and a chain-like structure material.

Each component is explained below.

### 1) Resin Component

The resin component acts as a binder for the black microparticles and chain-like structure material. The material for the resin component is not particularly limited, and both thermoplastic resins and thermosetting resins can be used. Specific examples of thermosetting resins include acrylic resins, polyurethane resins, phenolic resins, melamine resins, urea resins, diallyl phthalate resins, unsaturated polyester resins, epoxy resins, alkyd resins, and the like. Examples of thermoplastic resins include polyacrylate resins, polyvinyl chloride resins, butyral resins, and styrene-butadiene copolymer resins.

From the perspectives of heat resistance, moisture resistance, solvent resistance, and surface hardness, thermosetting resins are preferred. Considering flexibility and coating toughness, acrylic resins among thermosetting resins are particularly preferred. On the other hand, in cases where coating toughness is not as critical, thermoplastic acrylic resins are preferred, as they allow the thermal curing step to be omitted.

By adding a curing agent as a component of the light shielding layer, the crosslinking of the resin component can be promoted. Curing agents that can be used include urea compounds, melamine compounds, isocyanate compounds, epoxy compounds, aziridine compounds, and oxazoline compounds. Among these, isocyanate compounds are particularly preferred. Preferably, the curing agent is used in a content of 10% to 50% by mass relative to 100% by mass of the resin component. By adding the curing agent within this range, a light shielding layer with appropriate hardness can be obtained, which maintains its surface shape over time, even when sliding against other components, and preserves its low gloss.

When a curing agent is used, a reaction catalyst can also be used to promote the curing reaction. Examples of reaction catalysts include ammonia, ammonium chloride, and the like. Preferably, the reaction catalyst is used in a content of 0.1% to 10% by mass relative to 100% by mass of the curing agent.

### 2) Black Microparticles

The black light shielding component of the present invention contains black microparticles in the light shielding layer.

As shown in FIG. 1, black microparticles 32 form a fine uneven surface on the light shielding layer 3. By scattering light on this uneven surface, the gloss can be reduced. Furthermore, the black microparticles 32 absorb light, causing repeated scattering and absorption, which reduces the reflected light and achieves lower gloss.

FIG. 1 illustrates a structure in which the light shielding layer 3 containing black microparticles 32 covers the surface of a flat substrate 2. However, as described above, a substrate with an uneven surface formed through matte processing can also be used.

In the present invention, the desired gloss level can be achieved by controlling the uneven shape of the surface of the light shielding layer 3 using known methods. The surface shape of the light shielding layer 3 can be controlled by adjusting factors such as the surface shape of the substrate 2, the particle size, particle size distribution, and content of the black microparticles 32, and the thickness of the light shielding layer 3. Additionally, control can be achieved by adjusting factors such as the type of solvent used when preparing the coating liquid, the concentration of solids, and the amount applied to the substrate. Furthermore, control can be achieved by adjusting coating methods, drying temperature, drying time, and airflow during drying.

The average particle size of the black microparticles in the present invention is not particularly limited as long as the desired surface shape of the light shielding layer can be obtained. However, an average particle size of 0.1 μm to 50 μm is preferred, with 1 μm to 10 μm being more preferred. By setting the average particle size of the black microparticles within this range, a fine uneven surface can be formed on the light shielding layer, further reducing the gloss.

The content of the black microparticles depends on the average particle size, particle size distribution, and thickness of the light shielding layer, as well as the surface shape of the substrate. When the entire light shielding layer is considered to be 100% by volume, the content of the black microparticles is preferably 25% to 93% by volume, more preferably 50% to 88% by volume.

By setting the content of the black microparticles within this range, a balance between excellent blackness and low gloss can be achieved.

The volume content (volume ratio) of the black microparticles in the light shielding layer can be determined by converting the cross-sectional photograph of the light shielding layer into an area ratio calculated through image analysis or other methods.

Black microparticles can also be made from either resin-based or inorganic particles. Examples of materials for resin-based particles include melamine resin, benzoguanamine resin, benzoguanamine/melamine/formaldehyde condensate, acrylic resin, polyurethane resin, styrene resin, fluororesin, silicone resin, and the like. On the other hand, examples of materials for inorganic particles include silica, alumina, calcium carbonate, barium sulfate, titanium oxide (titania), and carbon. These materials can be used individually or in combination.

Additionally, when non-black materials are used, the microparticles can be colored black using organic or inorganic colorants, thereby converting them into black microparticles. Specific examples of such colorants include carbon black, aniline black, carbon nanotubes, and the like.

Examples of materials that are colored in this manner include composite silica, conductive silica, black silica, and black acrylic resins.

For example, composite silica can be a material synthesized and combined with nanoscale carbon black and silica, while conductive silica can be a material where conductive particles such as carbon black are coated on silica particles. Black silica can be a natural mineral that contains graphite in the silica stone. An example of black acrylic resin is an acrylic copolymer colored with carbon black.

To achieve superior characteristics, it is preferable to use inorganic particles as the black microparticles. By using inorganic particles as black microparticles, a black light shielding component with even lower gloss and higher blackness can be obtained. Among inorganic particle materials suitable for use as black microparticles, carbon is preferred. Among carbon particles, porous carbon particles are particularly preferred. Compared to non-porous black microparticles, using porous carbon particles offers the following benefits: light is repeatedly reflected and absorbed on the surface and inside the microparticles, resulting in attenuation. Additionally, when low-refractive-index nanoparticles are present, more of these nanoparticles can be retained on the surface and inside the porous carbon particles, which further reduces gloss.

There are no particular limitations on the shape of the black microparticles. However, in consideration of the flow characteristics of the coating liquid, coating properties, and the sliding properties of the obtained light shielding layer, ideally spherical black microparticles are preferred.

### 3) Chain-like Structure Material

A characteristic of the light shielding component of the present invention is that it contains a chain-like structure material within the light shielding layer.

As shown in FIG. 1, in the black light shielding component 1 of the present invention, the black microparticles 32 form a fine uneven surface on the surface of the light shielding layer 3. Here, the black microparticles 32 and chain-like structure material 33 are dispersed in the resin component 31 (binder resin) of the light shielding layer 3, and the air-layer-facing surface of the black microparticles 32 is covered by the resin component 31, in which the chain-like structure material 33 is dispersed. Additionally, as previously mentioned, the chain-like structure material 33 is simplified and represented as black dots in FIG. 1.

In the black light shielding component of the present invention, where the chain-like structure material 33 is dispersed, as shown in FIG. 2(A), aggregation (dense packing) is unlikely to occur in the light shielding layer 3. The primary particles that make up the chain-like structure material 33 have a particle size smaller than the wavelength of visible light, and when not aggregated, the reflection of visible light, including both long-wavelength light (LW in FIG. 2) and short-wavelength light (SW in FIG. 2), is suppressed. As a result, it is thought that a black color that is closer to pure black can be achieved. Furthermore, it is believed that by adding the chain-like structure material 33, an uppermost surface layer containing air (n_{d}=1.00) is formed on the surface of the light shielding layer 3. Air is also drawn between the particles making up the chain-like structure material 33 inside the light shielding layer 3, thereby lowering the refractive index of the light shielding layer 3. This reduces the difference in refractive index between the light shielding layer 3 and the air layer, further suppressing the reflection of visible light on the surface of the light shielding layer 3. As a result, a black color with higher blackness, closer to pure black, can be achieved.

The chain-like structure material comprises a long-chain part and side-chain parts. In the long-chain part, nanoscale primary particles are connected in a linear arrangement and extend in a certain direction, while the side-chain parts branch off from the long-chain part. The chain-like structure material includes not only linear chain-like structure but also pearl necklace-like structure.

The average particle diameter of the primary particles making up the chain-like structure material is preferably in the range of 3 nm to 50 nm, and the number of primary particles forming one chain-like structure material is preferably in the range of 2 to 100. Furthermore, the average length of the long-chain part of the chain-like structure material is preferably in the range of 6 nm to 500 nm, with the ratio of the average length of the long-chain part to the average particle diameter of the primary particles being in the range of 2 to 50.

Examples of chain-like structure materials include chain-like silica, chain-like zirconia, chain-like antimony oxide, and chain-like alumina (aluminum oxide). Chain-like structure materials preferably include low-refractive-index chain-like structure materials, and chain-like silica is particularly preferred. The term “low refractive index” here refers to a refractive index of 1.5 or lower.

The chain-like structure materials described above can be used individually or in combination. For instance, chain-like structure materials with different compositions, primary particle sizes, long-chain lengths, or ratios of long-chain length to primary particle diameter can be mixed. Combinations of chain-like structure materials with different compositions include combinations of low-refractive-index chain-like structure materials with chain-like structure materials that do not have a low refractive index (hereinafter referred to as “non-low-refractive-index chain-like structure materials”), combinations of low-refractive-index chain-like structure materials with different compositions, or combinations of non-low-refractive-index chain-like structure materials with different compositions.

The total content of black microparticles 32 and chain-like structure materials 33 in the light shielding layer 3 of the black light shielding component 1 of the present invention is not particularly limited, as long as the desired properties can be achieved. However, when considering the entire light shielding layer as 100% by volume, the total content is preferably in the range of 50% to 95% by volume, more preferably in the range of 60% to 90% by volume.

Within this range, higher blackness and lower reflectivity can be achieved while maintaining excellent adhesion strength, resulting in a black color closer to pure black.

The mixing ratio of black microparticles 32 to chain-like structure materials 33 is also not particularly limited as long as the desired properties can be achieved. However, the chain-like structure material 33 preferably constitutes 1% to 50% by volume of the total amount of black microparticles 32 and chain-like structure materials 33, more preferably 2% to 25% by volume. By adjusting the mixing ratio within this range, superior low gloss and blackness can be achieved. Additionally, within this range, the interface between the substrate 2 and the light shielding layer 3, as well as the interface between the particles and the resin component 31, will adhere sufficiently, ensuring that the light shielding layer 3 does not peel off during processing, providing excellent processability.

The volume content (volume occupancy) of the chain-like structure material 33 in the light shielding layer 3 can also be determined by converting the cross-sectional image of the light shielding layer 3 into an area occupancy ratio calculated through image analysis or similar methods.

### 4) Low Refractive Index Nanoparticles (Excluding Low Refractive Index Chain-Like Structure Materials)

The light shielding component of the present invention may include low refractive index nanoparticles in the light shielding layer. In cases where the chain-like structure material is a low refractive index chain-like structure material, it may also function as low refractive index nanoparticles. However, different low refractive index nanoparticles may also be added. Furthermore, in cases where the chain-like structure material is not a low refractive index chain-like structure material, low refractive index nanoparticles can be added.

The attenuation behavior of incident light will now be described for the case in which the chain-like structure material 33 dispersed in the light shielding layer 3 in FIG. 1 is a low refractive index chain-like structure material, or for the case in which low refractive index nanoparticles are added in addition to the chain-like structure material 33.

The incident light reaches the surface of the black microparticles 32 through the resin component 31, which contains the low refractive index chain-like structure material or the combination of the chain-like structure material and low refractive index nanoparticles (hereinafter referred to as “low refractive index nanoparticles, etc.”). A portion of the light is transmitted and absorbed by the black microparticles, while another portion is reflected. Here, since the black microparticles 32 are covered with the resin component 31, which contains low refractive index nanoparticles, etc., surface reflections on the resin component 31 are suppressed. Therefore, it is thought that in this component, compared to a light shielding component where the black microparticles 32 are covered with a resin component that does not contain low refractive index nanoparticles, etc., more light is transmitted through the resin component 31 and absorbed by the black microparticles 32, and as a result, the reflected light can be effectively reduced.

Additionally, a portion of the incident light reaching the surface of the light shielding layer 3, which is the interface between the air layer and the resin component 31 not covering the black microparticles 32, is transmitted, and another portion is reflected. In the black light shielding component 1 of this embodiment, compared to a light shielding component that uses a resin component without low refractive index nanoparticles, etc., the light reflected at the interface between the air layer and the resin component 31 of the light shielding layer 3 is reduced, and the amount of light transmitted through the resin component 31 of the light shielding layer 3 is increased. Furthermore, the light transmitted through the resin component 31 of the light shielding layer 3 is reflected at the interface between the substrate 2 and the light shielding layer 3, i.e., the surface of the substrate 2, and is absorbed by the black microparticles 32 in the light shielding layer 3. In this embodiment, it is thought that due to the synergistic effects of the low refractive index chain-like structure material and the low refractive index nanoparticles, further low gloss, high blackness, and a black color close to pure black can be achieved.

Here, low refractive index nanoparticles refer to nanoparticles with a refractive index of 1.5 or less and an average primary particle diameter of less than 250 nm. The preferred average primary particle diameter of the low refractive index nanoparticles is 1 nm to 200 nm, more preferably 5 nm to 150 nm, further preferably 10 nm to 100 nm, and most preferably 20 nm to 80 nm. By setting the refractive index and average primary particle diameter of the low refractive index nanoparticles within the above range, the refractive index of the light shielding layer can be effectively reduced, further enhancing blackness.

As long as the material of the low refractive index nanoparticles meets the above conditions, it can be an inorganic material, an organic material, a mixture or a composite of organic and inorganic materials. Examples of inorganic materials include fluorides such as thiolite (Na₅Al₃F₁₄, n_{d}=1.33), cryolite (Na₃AlF₆, n_{d}=1.35), sodium fluoride (NaF, n_{d}=1.34), lithium fluoride (LiF, n_{d}=1.36), aluminum fluoride (AlF₃, n_{d}=1.36), magnesium fluoride (MgF₂, n_{d}=1.38), calcium fluoride (CaF₂, n_{d}=1.43), and barium fluoride (BaF₂, n_{d}=1.48); oxides such as silicon dioxide (SiO₂, n_{d}=1.47); and carbonates such as calcium carbonate (CaCO₃, n_{d}=1.50). Examples of organic materials include nanoparticles (submicron particles) of acrylic resin (n_{d}=1.49 to 1.50), styrene resin, silicone resin (n_{d}≈1.43), and fluororesin (n_{d}≈1.35). Moreover, organic-inorganic hybrid materials such as organic-inorganic nanocomposites formed by combining metal oxides with organic molecules may also be used.

From the perspective of chemical stability, preferred materials for the low refractive index nanoparticles include magnesium fluoride, calcium fluoride, lithium fluoride, calcium carbonate, and silicon dioxide (silica).

Examples of low refractive index nanoparticles include nano-spherical particles (spherical nanoparticles), nano-hollow particles (hollow nanoparticles), nano-clay particles, and nano-fiber particles. In particular, using nano-hollow particles further reduces the refractive index of the light shielding layer and decreases diffuse reflection, effectively improving blackness. Nano-hollow particles such as hollow silica nanoparticles can be used.

Additionally, low refractive index nanoparticles (excluding low refractive index chain-like structure materials) can be of different or same composition as the low refractive index chain-like structure material. They may be used alone or in combination of two or more. With such a configuration, blackness can be further enhanced. For example, it has been confirmed that using both chain-like silica and magnesium fluoride nanoparticles results in lower reflectance across the entire visible spectrum, including the short-wavelength region, compared to using chain-like silica alone, achieving a black color closer to pure black.

The total content of the black microparticles, chain-like structure materials, and low refractive index nanoparticles in the light shielding layer of the black light shielding component of the present invention is not particularly limited as long as the desired characteristics are achieved. However, assuming the total volume of the light shielding layer is 100%, the total content is preferably 40 to 95 vol %, more preferably 60 to 90 vol %.

Additionally, when using a combination of chain-like structure materials and low refractive index nanoparticles, the mixing ratio is not particularly limited as long as the desired characteristics are achieved. However, the content of low refractive index nanoparticles (excluding the low refractive index chain-like structure materials) is preferably 1 to 90 vol % of the total amount of chain-like structure materials and low refractive index nanoparticles, more preferably 10 to 80 vol %. By adjusting the mixing ratio of the chain-like structure materials and low refractive index nanoparticles (excluding the low refractive index chain-like structure materials) within the above range, superior low gloss and blackness can be achieved. Moreover, due to the improved adhesion between the substrate and the light shielding layer as well as between the particles and the resin component, the light shielding layer will not peel off during processing, ensuring excellent workability. Furthermore, the volume fraction (volume occupancy) of low refractive index nanoparticles (excluding low refractive index chain-like structure materials) in the light shielding layer can be calculated by converting cross-sectional images of the light shielding layer into area occupancy through image analysis or similar techniques.

In the present invention, additional components such as leveling agents, thickeners, pH adjusters, lubricants, dispersants, and defoamers can also be added to the light shielding layer as necessary. As lubricants, in addition to solid lubricants such as polytetrafluoroethylene (PTFE) particles, polyethylene wax, silicone particles, etc., can also be used.

By adding the aforementioned components into an organic solvent or water and mixing and stirring, a uniform coating solution can be prepared. Examples of organic solvents that can be used include methyl ethyl ketone, toluene, propylene glycol monomethyl ether acetate, ethyl acetate, butyl acetate, methanol, ethanol, isopropanol, butanol, and others. The obtained coating solution is applied directly to the substrate surface or onto a previously formed anchor layer and then dried to form a light shielding layer. The coating method is not particularly limited, and methods such as spray coating, bar coating, roll coating, and doctor blade method can be used. Moreover, the concentration and solvent of the coating solution can be appropriately adjusted depending on the application, making it suitable for use as a superior black coating (paint). The thickness of the light shielding layer in this invention is preferably from 1 μm to 100 μm, more preferably from 2 μm to 50 μm, and even more preferably from 3 μm to 25 μm. By setting the thickness of the light shielding layer within this range, the desired blackness and anti-reflective effect can be appropriately achieved. The thickness of the light shielding layer refers to the height from the substrate surface to the matrix portion of the light shielding layer that does not protrude by the black microparticles. The thickness of the light shielding layer can be measured based on JIS K7130.

The characteristics of the black light shielding component of the present invention are described below.

### (1) Gloss

The gloss of the surface of the black light shielding component of the present invention, which has a light shielding layer, with respect to incident light at a 60° angle, is preferably 1% or less, more preferably 0.8% or less, even more preferably 0.6% or less, and most preferably 0.4% or less. By adjusting the gloss of the black light shielding component of the present invention to the above range for incident light at a 60° angle, flare and ghost phenomenon caused by diffuse reflection of light can be more effectively prevented. The gloss can be measured based on the specular gloss at a 60° angle according to JIS Z8741.

### (2) Blackness and Chromaticity in the Blue Direction

The L value of the surface of the black light shielding component of the present invention, which has a light shielding layer, is preferably 10 or less, more preferably 8 or less, and even more preferably 7 or less. By adjusting the L value of the black light shielding component of the present invention to the above range, high blackness and superior black color with excellent design properties can be achieved, making it suitable for applications such as camera units in mobile phones like smartphones.

The L value represents the brightness (L*) value in the L*a*b* color space, which is calculated based on JIS Z8781-4. Additionally, a* and b* represent chromaticity, which indicates hue and saturation, with a* indicating red direction and −a* indicating green direction, while b* indicates yellow direction and −b* indicates blue direction. In the present invention, −b* values are preferably closer to 0 than 0.8, namely b* values are preferably −0.8 or more and less than 0.8, and more preferably −0.4 or more and less than 0.4. By setting the b* value within the above range, the black light shielding component can suppress blue tint and be suitable for applications that require black colors closer to pure black.

### (3) Spectral Reflectance

The spectral reflectance of the surface of the black light shielding component of the present invention, which has a light shielding layer, with respect to visible light, is preferably 0.8% or less, more preferably 0.65% or less. By adjusting the spectral reflectance of the black light shielding component of the present invention to the above range, a black color closer to pure black can be achieved. Additionally, since the issue of increased spectral reflectance becomes more severe at shorter wavelength ranges, this specification may also use the reflectance of light at a wavelength of 360 nm for evaluation. The spectral reflectance can be measured using a spectrophotometer (CM-5, manufactured by KONICA MINOLTA) according to JIS Z8722.

### (4) Adhesion Strength

The adhesion strength of the surface of the black light shielding component of the present invention, which has a light shielding layer, is preferably 1 N/25 mm or more, more preferably 2 N/25 mm or more, even more preferably 4 N/25 mm or more, and most preferably 6 N/25 mm or more. By adjusting the adhesion strength of the black light shielding component of the present invention to the above range, the peeling of the light shielding layer's coating film during processing can be prevented, thereby improving workability.

The adhesion strength can be measured according to JIS Z0237 by measuring the resistance when peeling off 31B adhesive tape (manufactured by Nitto Denko Corporation) attached to the light shielding layer in a 180° direction. Additionally, the 31B adhesive tape can be applied to the light shielding layer using a 2 kg roller.

### Example

The present invention will be described in more detail by the following examples, but the invention is not limited to these examples. In the examples, unless otherwise noted, “%” and “parts” refer to mass percent and parts by mass, respectively.

### <Structure of Black Light Shielding Component>

### (1) Substrate

(1-1) Polyimide film Kapton 50MBC (thickness 12 μm), manufactured by DuPont-Toray Co., Ltd.

### (2) Light Shielding Layer

### (a) Microparticles

(a1) Porous carbon particles, average particle size: 3 μm, refractive index: approximately 1.55
(a2) Carbon microparticles, average particle size: 250 nm, refractive index: 1.80
(a3) Acrylic resin microparticles, average particle size: 3 μm, refractive index: 1.49

### (b) Chain-like Structure Materials

(b1) Chain-like silica, average particle size: 12 nm
(b2) Chain-like alumina, average particle size: 10 nm

### (c) Low Refractive Index Nanoparticles

(c1) Magnesium fluoride, average particle size: 50 nm, refractive index: approximately 1.38
(c2) Spherical silica, average particle size: 45 nm, refractive index: approximately 1.44
(c3) Spherical silica, average particle size: 12 nm, refractive index: approximately 1.44
(c4) Hollow silica, average particle size: 60 nm, refractive index: approximately 1.30

### (d) Resin

(d1) Acrylic resin: Paraclon Precoat 200, manufactured by Negami Industry Co., Ltd.
(d2) Acrylic resin: Acridic A801, manufactured by DIC Corporation

### (e) Curing Agent

(e1) Polyisocyanate: Takenate D110N, manufactured by Mitsui Chemicals, Inc.

### Examples 1-10, Comparative Examples 1-6, Reference Examples 1-2

The components of the light shielding layer were added into a solvent and mixed and stirred according to the proportions shown in Table 1 (FIG. 5) and Table 2 (FIG. 6) (based on the mass of solid components) to obtain a coating solution. Here, methyl ethyl ketone and toluene were used as solvents. The coating solution compositions in Tables 1 and 2 were applied to one surface of a polyimide film substrate and dried at 150° C. for 5 minutes to form a light shielding layer. No anchor layer was applied to the polyimide film, and the coating solution was applied directly to the substrate surface. The average film thickness of the light shielding layer formed in the above manner, as well as the gloss with respect to incident light at a 60° angle, the L value, b* value, and spectral reflectance, were evaluated, and the results are shown in Tables 1 and 2. In addition, the gloss with respect to incident light at a 60° angle, the L value, the b* value, and the spectral reflectance were evaluated according to the following evaluation standards, and the results are also shown in Tables 1 and 2.

(Evaluation Standards for Gloss with Respect to Incident Light at a 60° Angle)
x: 1% or more (does not meet the required characteristics of the present invention)
∘: 0.4% or more and less than 1% (excellent)
⊚: Less than 0.4% (very excellent)

### (Evaluation Standards for L Value)

x: More than 10 (does not meet the required characteristics of the present invention)
∘: More than 7 and 10 or less (excellent)
⊚: 7 or less (very excellent)

### (Evaluation Standards for b* Value)

x: Less than −0.8 or more than 0.8
∘: −0.8 or more and less than −0.4, or more than 0.4 and 0.8 or less
⊚: −0.4 or more and 0.4 or less

### (Evaluation Standards for Spectral Reflectance in the Short Wavelength Region: Evaluated by Reflectance of Light at 360 nm)

x: More than 0.8% (does not meet the requirements of the present invention)
∘: More than 0.65% and 0.8% or less (excellent)
⊚: 0.65% or less (very excellent)

### (Evaluation Standards for Adhesion Strength)

x: Less than 3 N/25 mm (including cases where measurement is impossible due to film peeling)
∘: 3 N/25 mm or more

In Reference Example 1, the evaluation results of a sample produced with the composition of a conventional general light shielding component are shown in Table 1. The light shielding component in Reference Example 1 has a structure in which a light shielding layer containing resin components, matting agents, and black pigments covers the substrate. In Reference Example 1, the matting agent is acrylic resin microparticles (colorless and transparent), and the black pigment is carbon microparticles. It is considered that in such conventional light shielding component, the fine uneven surface of the light shielding layer formed by the matting agent scatters light, and the black pigment dispersed in the resin component absorbs light, reducing the reflected light, thereby achieving low gloss.

However, in Reference Example 1, while the adhesion strength is good at 10.7 N/25 mm, the gloss at 60° is 2.7%, and the L value is as high as 26.5, with high reflectance over the entire visible light range, making it impossible to achieve the target low gloss and blackness level of the present invention. The reason for this is thought to be as follows. That is, because the light shielding layer in Reference Example 1 contains dispersed carbon microparticles, the refractive index is high, and the difference in refractive index between the light shielding layer and the air layer, as well as the aggregation of carbon microparticles, increases the diffuse reflection on the surface of the light shielding layer, resulting in a whitening appearance due to the scattering of diffuse light from the uneven surface.

TABLE 1

| | | | | | | Compar- | Compar- | |
|---|---|---|---|---|---|---|---|---|
| | | | | | | ative | ative | |
| | | | | Exam- | Exam- | Exam- | Exam- | Exam- |
| | | | | ple 1 | ple 10 | ple 1 | ple 2 | ple 2 |
| Compo- | (a)Microparticle | (a1)Black microparticles | Porous carbon particles Average | 100 | 100 | 100 | 100 | 100 |
| sition | | | particle size: 3 μm | | | | | |
| | | (a2)Black microparticles | Carbon Microparticles Average | | | | | |
| | | | particle size: 250 nm | | | | | |
| | | (a3)Acrylic resin | Average particle size: 3 μm | | | | | |
| | | microparticles | | | | | | |
| | (b)Chain-like | (b1)Chain-like silica | Silica Average particle size: 12 nm | 100 | | | | 100 |
| | Structure Material | (b2)Chain-like [symbol] | [symbol] Average particle size: 10 nm | | 100 | | | |
| | (c)Low Refractive | (c1)Fluoride nanoparticles | Magnesium [symbol] Average | | | | | 40 |
| | Index | | particle size: 50 nm | | | | | |
| | Nanoparticles | (c2)Spherical Nanoparticles | Spherical silica Average | | | 100 | | |
| | | | particle size: 45 nm | | | | | |
| | | (c3)Spherical Nanoparticles | Spherical silica Average | | | | 100 | |
| | | | particle size: 12 nm | | | | | |
| | | (c4)Hollow Nanoparticles | Hollow silica Average | | | | | |
| | | | particle size: 60 nm | | | | | |
| | (d)Resin | Binder component | (d1)Acrylic Resin (Precoat 200) | 100 | 100 | 100 | 100 | 100 |
| | (e)Curing Agent | | (d2)Acrylic Resin (Acidic A801) | | | | | |
| | | | (e)Polyisocyanate (Takenate D110N) | | | | | |

| | | | | | |
|---|---|---|---|---|---|
| Black Microparticles/Total light shielding layer (volume %) | 73 | 75 | | | |
| (Black microparticles + Chain-Like Structure | 82 | 81 | 73 | 73 | 79 |
| Materials)/Total light shielding layer (volume %) | | | | | |
| (Black microparticles + Chain-like Structure Materials + | 82 | 81 | 82 | 82 | 82 |
| Low Refractive Index Nanoparticles)/Total light shielding | | | | | |
| layer (volume %) | | | | | |
| Chain-like Structure Materials/(Chain-like Structure | 100 | 100 | — | — | 75 |
| Materials + Low Refractive Index Nanoparticles) | | | | | |
| (volume %) | | | | | |

| Measure- | Layer thickness (μm) | | 10 | 10 | 10 | 10 | 10 |
|---|---|---|---|---|---|---|---|
| ment | Gloss 60° (%) | | 0.1 | 0.1 | 0.1 | 0.1 | 0.1 |
| results | Blackness: L* | | 6.6 | 7.1 | 6.7 | 6.6 | 5.2 |
| | Yellow + Blue−: b* | | −0.4 | −0.3 | — | — | −0.4 |
| | Spectral reflectance | 360 nm | 0.76 | 0.79 | 0.97 | 0.83 | 0.62 |
| | (%) | 400 nm | 0.76 | 0.79 | 0.88 | 0.79 | 0.64 |
| | | 450 nm | 0.74 | 0.78 | 0.80 | 0.74 | 0.60 |
| | | 500 nm | 0.74 | 0.78 | 0.77 | 0.72 | 0.58 |
| | | 550 nm | 0.72 | 0.77 | 0.74 | 0.72 | 0.57 |
| | | 600 nm | 0.71 | 0.77 | 0.73 | 0.75 | 0.58 |
| | | 650 nm | 0.73 | 0.78 | 0.75 | 0.77 | 0.59 |
| | | 700 nm | 0.76 | 0.79 | 0.79 | 0.80 | 0.58 |
| | | 740 nm | 0.77 | 0.80 | 0.79 | 0.80 | 0.58 |

| Evaluation | Gloss 60° (%) | ⊚ | ⊚ | ⊚ | ⊚ | ⊚ |
|---|---|---|---|---|---|---|
| results | Blackness: L* | ⊚ | ⊚ | ⊚ | ⊚ | ⊚ |
| | Yellow + Blue−: b* | ⊚ | ⊚ | — | — | ⊚ |
| | Spectral reflectance in the short | ◯ | ◯ | X | X | ⊚ |
| | wavelength range (%) | | | | | |
| | Adhesive strength | ◯ | ◯ | ◯ | ◯ | ◯ |

| | | | | Compar- | Compar- | Compar- | Refer- | Refer- |
|---|---|---|---|---|---|---|---|---|
| | | | | ative | ative | ative | ence | ence |
| | | | | Exam- | Exam- | Exam- | Exam- | Exam- |
| | | | | ple 3 | ple 4 | ple 5 | ple 1 | ple 2 |
| Compo- | (a)Microparticle | (a1)Black microparticles | Porous carbon particles Average | 100 | 100 | 100 | | 200 |
| sition | | | particle size: 3 μm | | | | | |
| | | (a2)Black microparticles | Carbon Microparticles Average | | | | 114 | |
| | | | particle size: 250 nm | | | | | |
| | | (a3)Acrylic resin | Average particle size: 3 μm | | | | 96 | |
| | | microparticles | | | | | | |
| | (b)Chain-like | (b1)Chain-like silica | Silica Average particle size: 12 nm | | | | | |
| | Structure Material | (b2)Chain-like [symbol] | [symbol] Average particle size: 10 nm | | | | | |
| | (c)Low Refractive | (c1)Fluoride nanoparticles | Magnesium [symbol] Average | 40 | 40 | 40 | | |
| | Index | | particle size: 50 nm | | | | | |
| | Nanoparticles | (c2)Spherical Nanoparticles | Spherical silica Average | 100 | | | | |
| | | | particle size: 45 nm | | | | | |
| | | (c3)Spherical Nanoparticles | Spherical silica Average | | 100 | | | |
| | | | particle size: 12 nm | | | | | |
| | | (c4)Hollow Nanoparticles | Hollow silica Average | | | 100 | | |
| | | | particle size: 60 nm | | | | | |
| | (d)Resin | Binder component | (d1)Acrylic Resin (Precoat 200) | 100 | 100 | 100 | | 100 |
| | (e)Curing Agent | | (d2)Acrylic Resin (Acidic A801) | | | | 62 | |
| | | | (e)Polyisocyanate (Takenate D110N) | | | | 38 | |

| | | | | | |
|---|---|---|---|---|---|
| Black Microparticles/Total light shielding layer (volume %) | | | | | |
| (Black microparticles + Chain-Like Structure | 71 | 71 | 60 | 27 | 89 |
| Materials)/Total light shielding layer (volume %) | | | | | |
| (Black microparticles + Chain-like Structure Materials + | 82 | 82 | 85 | 27 | 89 |
| Low Refractive Index Nanoparticles)/Total light shielding | | | | | |
| layer (volume %) | | | | | |
| Chain-like Structure Materials/(Chain-like Structure | — | — | — | — | — |
| Materials + Low Refractive Index Nanoparticles) | | | | | |
| (volume %) | | | | | |

| Measure- | Layer thickness (μm) | | 10 | 10 | 10 | 4 | 10 |
|---|---|---|---|---|---|---|---|
| ment | Gloss 60° (%) | | 0.1 | 0.1 | 0.1 | 2.7 | 0.1 |
| results | Blackness: L* | | 6.2 | 6.6 | 6.2 | 25.5 | 7.8 |
| | Yellow + Blue−: b* | | −1.5 | −1.2 | −0.5 | 1.9 | 0.7 |
| | Spectral reflectance | 360 nm | 0.89 | 0.93 | 0.82 | 4.23 | 0.79 |
| | (%) | 400 nm | 0.89 | 0.88 | 0.76 | 4.36 | 0.79 |
| | | 450 nm | 0.81 | 0.82 | 0.71 | 4.47 | 0.81 |
| | | 500 nm | 0.74 | 0.76 | 0.70 | 4.70 | 0.86 |
| | | 550 nm | 0.68 | 0.71 | 0.69 | 4.87 | 0.86 |
| | | 600 nm | 0.64 | 0.71 | 0.65 | 5.06 | 0.37 |
| | | 650 nm | 0.67 | 0.70 | 0.65 | 5.28 | 0.91 |
| | | 700 nm | 0.65 | 0.7 [symbol] | 0.68 | 5.59 | 0.93 |
| | | 740 nm | 0.64 | 0.69 | 0.67 | 5.69 | 0.96 |

| Evaluation | Gloss 60° (%) | ⊚ | ⊚ | ⊚ | X | ⊚ |
|---|---|---|---|---|---|---|
| results | Blackness: L* | ⊚ | ⊚ | ⊚ | X | ◯ |
| | Yellow + Blue−: b* | X | X | ◯ | X | ◯ |
| | Spectral reflectance in the short | X | X | X | X | ◯ |
| | wavelength range (%) | | | | | |
| | Adhesive strength | ◯ | ◯ | ◯ | ◯ | X |

[symbol]

indicates data missing or illegible when filed

In Reference Example 2, the evaluation results of a sample produced by adding porous carbon particles, which serve as black microparticles, in place of the colorless transparent acrylic resin microparticles used as a matting agent in order to lower the L value and increase blackness are shown. The light shielding component in Reference Example 2 has a structure in which a light shielding layer containing resin components and black microparticles covers the substrate. It is found that the light shielding component of Reference Example 2 achieves low gloss with a gloss of 0.1% at 60°, and with an L value of 7.8, it achieves significantly higher blackness compared to Reference Example 1. However, in Reference Example 2, the adhesion strength is as low as 0.1 N/25 mm, suggesting that even a light touch during handling may cause the powder constituting the light shielding layer to fall off, making it difficult to commercialize. In Reference Example 2, the addition amount of black microparticles was increased in order to lower the L value to the desired value. As a result, the proportion of resin components in the light shielding layer was decreased, and it is thought that sufficient adhesion could not be achieved between the substrate and the light shielding layer, as well as between the resin components and the black microparticles.

In Comparative Example 1, the amount of black microparticles was set to half of that in Reference Example 2, and spherical silica nanoparticles (average particle size: 45 nm, refractive index: 1.44) were added as low refractive index nanoparticles. It was confirmed that the sample of Comparative Example 1 achieved low gloss with a gloss of 0.1% at 60°, and with an L value of 6.7, it exhibited even higher blackness than Reference Example 2. This is thought that because the dispersion of low refractive index nanoparticles in the light shielding layer reduces the refractive index of the light shielding layer, decreasing the refractive index difference with the air layer, thereby reducing the scattered light on the surface of the light shielding layer, and the scattered light is absorbed and reflected by the black microparticles, significantly attenuating the light. Furthermore, it was confirmed that Comparative Example 1, containing black microparticles and low refractive index nanoparticles, also exhibited good adhesion strength of 3 N/25 mm or more.

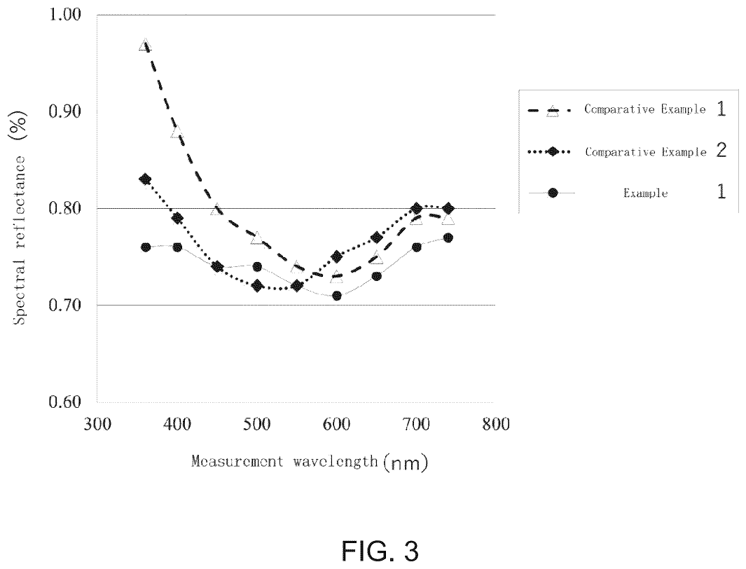

However, as shown in Table 1 and FIG. 3, in Comparative Example 1, the spectral reflectance in the visible light region on the short-wavelength side increased sharply. This is likely due to the relatively large particle size of the spherical silica nanoparticles in Comparative Example 1, which allows transmission of long-wavelength visible light but increases reflection of short-wavelength visible light as shown in FIG. 2(B). Therefore, it is expected that the application of Comparative Example 1, with high spectral reflectance on the short-wavelength side, as a design-oriented black light shielding component close to pure black, would be difficult.

Next, the average particle size of the spherical silica nanoparticles was changed from 45 nm to 12 nm, and a light shielding layer coating film was produced and evaluated in the same manner as in Comparative Example 1 (Comparative Example 2). It was confirmed that in Comparative Example 2, the gloss at 60° was 0.1%, the L value was 6.6, and similar to Comparative Example 1, the sample exhibited low gloss and high blackness, with good adhesion.

Additionally, as shown in Table 1 and FIG. 3, in Comparative Example 2, the spectral reflectance on the short-wavelength side decreased compared to Comparative Example 1. This is thought that because in Comparative Example 2, the average particle size of the spherical silica nanoparticles is smaller than that of Comparative Example 1 as shown in FIG. 2(C), limits the reflection of incident light to areas densely packed with spherical silica nanoparticles, thereby suppressing surface reflection of incident light.

However, as shown in FIG. 3, in Comparative Example 2, the spectral reflectance on the short-wavelength side increased and exceeded 0.8%, indicating room for improvement in its application as a design-oriented black light shielding component close to pure black.

In Example 1, where chain-like silica (average particle size: 12 nm) was added instead of the spherical silica nanoparticles used in Comparative Examples 1 and 2, it was confirmed that the sample exhibited low gloss and high blackness, with good adhesion, similar to Comparative Examples 1 and 2. As shown in Table 1 and FIG. 3, it was found that in Example 1, the spectral reflectance in the entire visible light region was 0.8% or less, showing excellent reflective properties, and the b* value was close to zero, achieving a black color close to pure black. This is considered to be due to the addition of the chain-like structure material, which inhibits particle aggregation, forms air-containing spaces between the chain-like particles, and lowers the refractive index of the light shielding layer.

A sample was produced and evaluated in the same manner as in Example 1, except that chain-like alumina was added instead of chain-like silica (Example 10). It was confirmed that in Example 10, the gloss at 60° was 0.1%, the L value was 7.1, and similar to Example 1, the sample exhibited low gloss and high blackness, with good adhesion. Furthermore, it was found that in Example 10, the spectral reflectance in the entire visible light region was 0.8% or less, showing excellent reflective properties, and the b* value was close to zero, achieving a black color close to pure black. As described above, it was confirmed that in Examples 1 and 10, which contain chain-like structure materials, the increase in spectral reflectance on the short-wavelength side was suppressed compared to Comparative Examples 1 and 2, and lower spectral reflectance at 360 nm was achieved. This indicates that by using chain-like structure materials, the phenomenon of the black color shifting towards blue can be suppressed regardless of the material, enabling a black color closer to pure black.

In addition, when comparing Example 1 and Example 10, it was found that in Example 1, which used a low refractive index chain-like structure material, namely chain-like silica, lower spectral reflectance was achieved across the entire visible light region. Therefore, it is thought that it is preferable to use a low refractive index chain-like structure material as the chain-like structure material. Next, further investigation was conducted using a low refractive index chain-like structure material, namely chain-like silica, as the chain-like structure material.

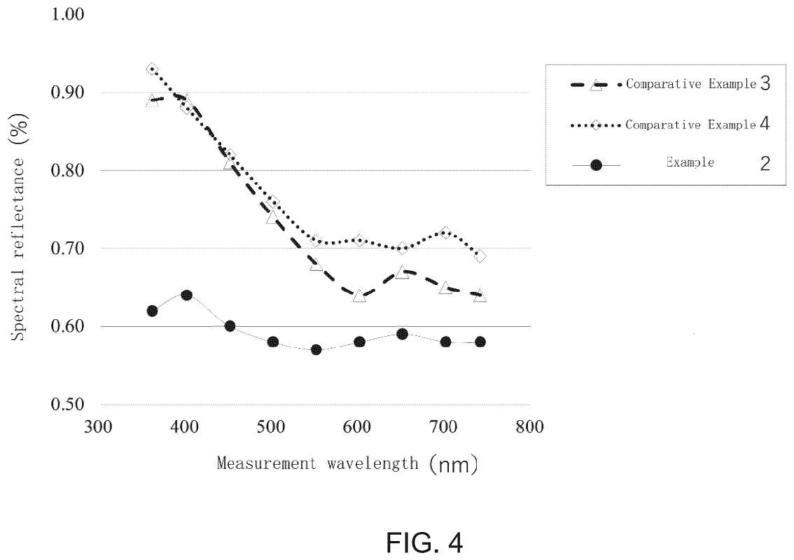

In Example 2, magnesium fluoride, a low refractive index nanoparticle, was further added to the composition of Example 1. As shown in Table 1, it can be seen that Example 2 achieves low gloss and good adhesion similar to Example 1. Additionally, it was confirmed that the L value in Example 2 is 5.2, indicating that blackness has further improved compared to Example 1. Furthermore, as shown in Table 1 and FIG. 4, it was confirmed that in Example 2, the spectral reflectance across the entire visible light region further decreased compared to Example 1, resulting in a black color closer to pure black.

In Comparative Examples 3 and 4, spherical silica nanoparticles with average particle sizes of 45 nm and 12 nm, respectively, were used instead of the chain-like silica in Example 2. As shown in FIG. 4, the spectral reflectance on the short-wavelength side sharply increased, and as shown in Table 1, the b* values shifted toward the blue side, failing to achieve the near-pure black color seen in Example 2.

In Comparative Example 5, hollow silica nanoparticles with an average particle size of 60 nm were used instead of the chain-like silica in Example 2. Compared to Comparative Examples 3 and 4, the spectral reflectance on the short-wavelength side decreased, and the b* value approached zero, indicating an improvement in the blue shift; however, it did not reach the results of Example 2.

From these results, it was confirmed that a significant synergistic effect is achieved by further adding low refractive index nanoparticles to the black light shielding component of the present invention containing chain-like structure materials.

Table 2 shows the evaluation results of various performance characteristics of samples made by adjusting the total amount of black microparticles and chain-like silica (in terms of mass) relative to the binder resin component while keeping the addition amount of black microparticles and chain-like silica same (Examples 3, 1, and 4). It was found that in Example 3, where the total volume of the black microparticles and chain-like structure materials was 80% with the overall light shielding layer set to 100% by volume, a low-gloss, high-blackness, and blue-shift-suppressed black color was obtained. Although not listed in the table, it was confirmed that Example 3 had sufficient adhesion strength.

In contrast, in Examples 1 and 4, where the total volume of black microparticles and chain-like structure materials was increased to 82% and 83% of the total volume of the light shielding layer, respectively, there was a tendency for the L value to decrease, and the reflectance across the entire wavelength range, including the short-wavelength side, decreased. This indicates that the addition of particles is effective in achieving a black color close to pure black. However, adding a large amount of particles leads to a decrease in adhesion strength for the light shielding layer and an increase in cost. Therefore, it is considered preferable for the total content of black microparticles and chain-like structure materials in the light shielding layer of the black light shielding component of the present invention to be 50% to 95% by volume, and more preferably 60% to 90% by volume, assuming the total volume of the light shielding layer is 100% by volume.

In Examples 5, 6, and 2, the total volume of black microparticles, chain-like structure materials (chain-like silica), and low refractive index nanoparticles (magnesium fluoride) relative to the overall volume of the light shielding layer was kept constant, and the volume ratio of chain-like structure materials (chain-like silica) to low refractive index nanoparticles (magnesium fluoride) was also kept constant, while the volume ratio of black microparticles to the total volume of chain-like structure materials (chain-like silica) and low refractive index nanoparticles was varied to produce samples.

The evaluation results of the various performance characteristics of these samples are shown in Table 2. In Examples 5, 6, and 2, with the total volume of the black microparticles, chain-like silica, and magnesium fluoride being 82% of the total light shielding layer volume, the volume contents of black microparticles relative to the total light shielding layer were 70%, 71%, and 73%, respectively.

It was confirmed that in Example 5, low gloss, high blackness, and a suppressed blue shift were achieved. Although not listed in the table, it was confirmed that Example 5 also had sufficient adhesion strength.

In Example 6, compared to Example 5, the L value decreased, the reflectance across the entire wavelength range decreased, and the b* value approached zero, achieving a black color closer to pure black. In Example 2, compared to Example 5, the L value decreased, the reflectance across the entire wavelength range decreased, and the b* value approached zero, achieving a black color closer to pure black. Therefore, there is a tendency that the higher the content of black microparticles relative to the total light shielding layer, the lower the b* value. From the above results, it was confirmed that the content of black microparticles is important for obtaining a black color with high blackness closer to pure black.

TABLE 2

| | | | | Exam- | Exam- | Exam- | Exam- | Exam- | Exam- |
|---|---|---|---|---|---|---|---|---|---|
| | | | | ple 3 | ple 1 | ple 4 | ple 5 | ple 6 | ple 2 |
| Compo- | (a)Microparticles | (a1)Black | Porous carbon particles average | 90 | 100 | 110 | 90 | 125 | 100 |
| sition | | microparticle | particle size: 3 μm | | | | | | |
| | (b)Chain-like | (b1)Chain-like | Silica Average particle | 90 | 100 | 110 | 90 | 125 | 100 |
| | Structure Materials | silica | size: 12 nm | | | | | | |
| | (c)Low Refractive | (c1)Fluoride | Magnesium fluoride Average | | | | 36 | 50 | 40 |
| | Index Nanoparticles | nanoparticle | particle size: 50 nm | | | | | | |
| | (d)Resin | Binder component | (d1)Acrylic Resin (Precoat 200) | 100 | 100 | 100 | 90 | 125 | 100 |

| | | | | | | |
|---|---|---|---|---|---|---|
| Black microparticles/Total light shielding layer (volume %) | 72 | 73 | 75 | 70 | 71 | 73 |
| Chain-Like Structure Materials/(Chain-like Structure | 10 | 10 | 10 | 10 | 10 | 10 |
| Materials + Black microparticles) (volume %) | | | | | | |
| (Black microparticles + Chain-like Structure Materials)/ | 80 | 82 | 83 | 79 | 79 | 79 |
| Total light shielding layer (volume %) | | | | | | |
| (Black microparticles + Chain-like Structure Material + | 80 | 82 | 83 | 82 | 82 | 82 |
| Low Refractive Index Nanoparticles)/Total light shielding | | | | | | |
| layer (volume %) | | | | | | |
| Chain Structure Materials/(Chain Structure Materials + | 100 | 100 | 100 | 75 | 75 | 75 |
| Low Refractive Index Nanoparticles) (volume %) | | | | | | |

| Measure- | Layer thickness (μm) | | 10 | 10 | 10 | 10 | 10 | 10 |
|---|---|---|---|---|---|---|---|---|
| ment | Gloss 60° (%) | | 0.1 | 0.1 | 0.1 | 0.1 | 0.1 | 0.1 |
| results | Blackness: L* | | 7.0 | 6.6 | 6.3 | 6.2 | 5.0 | 5.2 |
| | Yellow + Blue−: b* | | −0.2 | −0.4 | −0.1 | −0.7 | −0.6 | −0.4 |
| | Spectral | 360 nm | 0.80 | 0.76 | 0.74 | 0.80 | 0.64 | 0.62 |
| | reflectance | 400 nm | 0.80 | 0.76 | 0.77 | 0.75 | 0.62 | 0.64 |
| | (%) | 450 nm | 0.79 | 0.74 | 0.74 | 0.70 | 0.57 | 0.60 |
| | | 500 nm | 0.80 | 0.74 | 0.72 | 0.71 | 0.57 | 0.58 |
| | | 550 nm | 0.78 | 0.72 | 0.72 | 0.70 | 0.54 | 0.57 |
| | | 600 nm | 0.79 | 0.71 | 0.70 | 0.64 | 0.55 | 0.58 |
| | | 650 nm | 0.77 | 0.73 | 0.69 | 0.66 | 0.53 | 0.59 |
| | | 700 nm | 0.80 | 0.76 | 0.70 | 0.67 | 0.56 | 0.58 |
| | | 740 nm | 0.79 | 0.77 | 0.72 | 0.65 | 0.56 | 0.58 |

| Evaluation | Gloss 60° (%) | ⊚ | ⊚ | ⊚ | ⊚ | ⊚ | ⊚ |
|---|---|---|---|---|---|---|---|
| results | Blackness: L* | ⊚ | ⊚ | ⊚ | ⊚ | ⊚ | ⊚ |
| | Yellow + Blue−: b* | ⊚ | ⊚ | ⊚ | ◯ | ◯ | ⊚ |
| | Spectral reflectance in the short | ◯ | ◯ | ◯ | ◯ | ⊚ | ⊚ |
| | wavelength range (%) | | | | | | |

| | | | | | | | | Compar- |
|---|---|---|---|---|---|---|---|---|
| | | | | Exam- | Exam- | Exam- | Exam- | ative |
| | | | | ple 1 | ple 7 | ple 8 | ple 9 | Example 6 |
| Compo- | (a)Microparticles | (a1)Black | Porous carbon particles average | 100 | 100 | 100 | 100 | 100 |
| sition | | microparticle | particle size: 3 μm | | | | | |
| | (b)Chain-like | (b1)Chain-like | Silica Average particle | 100 | 75 | 50 | 25 | |
| | Structure Materials | silica | size: 12 nm | | | | | |
| | (c)Low Refractive | (c1)Fluoride | Magnesium fluoride Average | 0 | 25 | 50 | 75 | 100 |
| | Index Nanoparticles | nanoparticle | particle size: 50 nm | | | | | |
| | (d)Resin | Binder component | (d1)Acrylic Resin (Precoat 200) | 100 | 100 | 100 | 100 | 100 |

| | | | | | |
|---|---|---|---|---|---|
| Black microparticles/Total light shielding layer (volume %) | 73 | 74 | 74 | 74 | 74 |
| Chain-Like Structure Materials/(Chain-like Structure | 10 | 7.7 | 5.3 | 2.7 | — |
| Materials + Black microparticles) (volumne %) | | | | | |
| (Black microparticles + Chain-like Structure Materials)/ | 82 | 80 | 78 | 76 | 74 |
| Total light shielding layer (volume %) | | | | | |
| (Black microparticles + Chain-like Structure Material + | 82 | 82 | 82 | 81 | 81 |
| Low Refractive Index Nanoparticles)/Total light shielding | | | | | |
| layer (volume %) | | | | | |
| Chain Structure Materials/(Chain Structure Materials + | 100 | 78 | 54 | 28 | — |
| Low Refractive Index Nanoparticles) (volume %) | | | | | |

| | | | | | | |
|---|---|---|---|---|---|---|
| Measure- | Layer thickness (μm) | 10 | 10 | 10 | 10 | 10 |
| ment | Gloss 60° (%) | 0.1 | 0.1 | 0.1 | 0.1 | 0.1 |
| results | Blackness: L* | 6.6 | 5.7 | 6.1 | 6.7 | 7.3 |

| Yellow + Blue−: b* | | −0.4 | 0.23 | −0.22 | −0.14 | 0.45 |
|---|---|---|---|---|---|---|
| Spectral | 360 nm | 0.76 | 0.68 | 0.74 | 0.78 | 0.82 |
| reflectance | 400 nm | 0.76 | 0.63 | 0.72 | 0.77 | 0.80 |
| (%) | 450 nm | 0.74 | 0.61 | 0.67 | 0.73 | 0.79 |
| | 500 nm | 0.74 | 0.63 | 0.69 | 0.72 | 0.80 |
| | 550 nm | 0.72 | 0.61 | 0.66 | 0.71 | 0.80 |
| | 600 nm | 0.71 | 0.64 | 0.67 | 0.73 | 0.82 |
| | 650 nm | 0.73 | 0.65 | 0.66 | 0.72 | 0.84 |
| | 700 nm | 0.76 | 0.67 | 0.70 | 0.75 | 0.88 |
| | 740 nm | 0.77 | 0.66 | 0.71 | 0.76 | 0.92 |

| | | | | | | |
|---|---|---|---|---|---|---|
| Evaluation | Gloss 60° (%) | ⊚ | ⊚ | ⊚ | ⊚ | ⊚ |
| results | Blackness: L* | ⊚ | ⊚ | ⊚ | ⊚ | ◯ |

| | | | | | |
|---|---|---|---|---|---|
| Yellow + Blue−: b* | ⊚ | ⊚ | ⊚ | ⊚ | ◯ |
| Spectral reflectance in the short | ◯ | ◯ | ◯ | ◯ | X |
| wavelength range (%) | | | | | |

In Examples 1, 7, 8, 9, and Comparative Example 6 shown in Table 2, the volume of black microparticles relative to the total volume of the light shielding layer was set to 73% or 74%, and the volume ratio of chain-like silica relative to the total amount of chain-like structure materials and black microparticles was set to 10%, 7.7%, 5.3%, 2.7%, and 0%, respectively. Additionally, Example 1 does not contain magnesium fluoride, and Comparative Example 6 does not contain chain-like silica. It was found that in Examples 1, 7, 8, and 9, both the L value and b* value were low (approaching zero), and the spectral reflectance across the entire wavelength range also met the required values of the present invention. In contrast, in Comparative Example 6, which does not contain chain-like structure materials, the L value increased, the b* value deviated from zero, and the spectral reflectance across the entire wavelength range significantly increased. From these results, the effectiveness of the present invention, which contains chain-like structure materials, was confirmed.

### INDUSTRIAL APPLICABILITY

The present invention has high industrial applicability as a black light shielding component for optical instruments such as camera units for mobile phones. In addition, the coating solution used to form the light shielding layer of the black light shielding component of the present invention, which contains black microparticles, chain-like structure materials, and resin components, also has industrial applicability as a black paint.

### DESCRIPTION OF SYMBOLS

1 Light shielding component
2 Substrate
3 Light shielding layer
31 Resin component
32 Black microparticles
33 Chain-like structure material
331 Low refractive index nanoparticles

1. A black light shielding component comprising a substrate and a light shielding layer formed on at least one surface of the substrate, characterized in that the light shielding layer contains black microparticles, chain-like structure materials, and a resin component.

2. The black light shielding component according to claim 1, characterized in that the chain-like structure materials comprise a low refractive index chain-like structure material.

3. The black light shielding component according to claim 1, characterized in that the chain-like structure materials comprise chain-like silica.

4. The black light shielding component according to any one of claims 1 to 3, characterized in that the light shielding layer further contains low refractive index nanoparticles (excluding low refractive index chain-like structure materials).

5. The black light shielding component according to claim 4, characterized in that the low refractive index nanoparticles comprise magnesium fluoride particles.

6. The black light shielding component according to claim 1, characterized in that the total content of the black microparticles and chain-like structure materials in the light shielding layer is 50% to 95% by volume of the entire light shielding layer.

7. The black light shielding component according to claim 4, characterized in that the total content of the black microparticles, chain-like structure materials, and low refractive index nanoparticles in the light shielding layer is 40% to 95% by volume of the entire light shielding layer.

8. The black light shielding component according to claim 1, characterized in that the content of the chain-like structure materials is 1% to 50% by volume of the total volume of the black microparticles and the chain-like structure materials.

9. A black light shielding component comprising a substrate and a light shielding layer formed on at least one surface of the substrate, characterized in that the light shielding layer contains black microparticles, chain-like structure materials, and a resin component, and the spectral reflectance at a wavelength of 360 nm on the surface of the black light shielding component with the light shielding layer is 0.8% or less.

10. The black light shielding component according to claim 9, characterized in that the chain-like structure materials comprise chain-like silica.

11. The black light shielding component according to claim 9 or 10, characterized in that it further contains magnesium fluoride particles.

12. A composition for black paint, characterized in that it contains black microparticles, chain-like structure materials, and a resin component.

13. The composition for black paint according to claim 12, characterized in that the chain-like structure materials comprise chain-like silica.

14. The composition for black paint according to claim 12 or 13, characterized in that it further contains magnesium fluoride particles.
